(19) United States
(12) Patent Application Publication
(10) Pub. No.: US 2013/0117136 A1
(43) Pub. Date: May 9, 2013

(54) System and Method for Real-Time Price Change Monitoring

(71) Applicant: Max F. Krawinkel, Koeln (DE)

(72) Inventor: Max F. Krawinkel, Koeln (DE)

(73) Assignee: PWM GMBH CO. KG, Bergneustadt (DE)

(21) Appl. No.: 13/288,337

(22) Filed: Nov. 3, 2011

(51) Int. Cl. G06Q 20/20

(52) U.S. Cl. 705/16

(57) ABSTRACT

A system and method for verifying that a price sign has changed a displayed price correctly including a message control system that monitors communications between a controller and controller and one or more price signs at a retail sales location like a gasoline station. One or more messages is sent to a remote location such as a monitoring point or corporate headquarters when a displayed price does not change correctly upon command or whenever the price sign is commanded to change a displayed price. A typical message may be email to one or more particular recipients. In addition to monitoring or listening-in to communications between a sign controller and a price sign, the message control system can optionally perform diagnostics to check on the health of the sign controller, the sign, or both.

### BACKGROUND

1. Field of the Invention

The present invention relates generally to real-time monitoring and more particularly to monitoring price changes to electronic signs at retail locations, especially at gasoline stations.

2. Description of the Prior Art

Gasoline stations and other retail outlets use electronic price signs to display pricing information. Such signs stating the current price of different grades of gasoline, diesel fuel and commodities such as cigarettes as well as other products are common. Commodity prices may also be displayed on message boards using LEDs or other technology. These signs are many times tied to the facility's point of sale system. A price change command can be entered at the point of sale terminal or come into the point of sale system from a corporate entity. The new price is then reflected on both the price signs and the pumps. Sometimes price signs are controlled manually at the retail outlet, through a controller or wireless handheld unit. In these systems, price change commands are entered directly into a sign controller by the retailer to cause the sign to change. In systems where price changes come from a remote location into the point of sale and then the pumps and the price signs typically all change simultaneously upon receiving a remote price change command.

A major problem with current systems, especially those that require separate sign price entry, is that the sign may end up displaying a different price from the pumps or the point of sale system. This is true not only for gasoline retailers, but for any retailer that uses electronic or electric signage. The retailer usually has no feedback as to what is being displayed on various price signs without actually visually checking them. A corporate center that has ordered a price change to a chain of gasoline stations or the like has no feedback as to whether this price change is being correctly displayed on signs. It would be extremely advantageous to have a system and method of determining remotely and independently of the point of sale system whether a particular sign has changed correctly in response to a price change command, or if an error has occurred.

Another problem with remote electronic price signs is that there is no way to generally know if the sign is functioning properly, and whether it will respond correctly to the next price change command. It would be advantageous to have a system that could periodically and automatically run diagnostics on a sign or group of signs during times when no commands are being sent to the sign, where results of these diagnostics are either stored in a log file or sent to a remote location over the Internet or other network.

Such a system should transmit messages, especially messages that an error has occurred with respect to a particular price sign, over the Internet or other network in the form of email to certain recipients, through FTP download, or by sending files to a server that can later be retrieved remotely. These messages can completely detour the point of sale system.

It would also be advantageous if such a system could be updated over the Internet or other network from a remote location.

It would be advantageous to have a system where price feedback comes directly from the sign to the corporate center with no detour through the POS (which increases the risk of communication errors).

It would be advantageous to have a system with time stamps. Time stamps are a proof that the price was executed at the store level. At some stores the manager has to execute the price change shown on the POS display, coming from the corporate center, by pushing an “enter” button. However this allows the store manager to delay the price execution, especially when the price needs to be increased (the store is more attractive with lower pricing). The corporate center realizes this delay sometimes hours or a day later after receiving the receipts of the store sale. With time stamps, the corporate center can have direct price execution feedback to control the store level. Also, sometimes the store manager has the freedom to set pricing in a certain corridor to be price competitive. The corporate center gets the information with delay, as described above, and prefers direct feedback. It would be advantageous to have a system that eliminates this delay.

Finally, a system is needed that can listen-in and report directly over a network the content of messages from the network to an LED message board or other type of display.

### SUMMARY OF THE INVENTION

The present invention relates to a system and method for verifying that a price sign has changed a displayed price correctly. The system includes a message control system for monitoring communications between a controller and a price sign at a retail sales location such as a gasoline station. Based on this monitoring, the system causes the control system to send one or more messages to a remote location such as a monitoring point or corporate headquarters if a displayed price does not change correctly upon command. In some embodiments, the message control system sends a message whenever said price sign is commanded to change a displayed price. A typical message may be email to a particular recipient or any other type of message such as an FTP download. These messages can completely detour the point of sale system. The message control system can contain a stored list of recipients that can be changed remotely over the network. Also, an executable program in the message control system can be updated remotely. All sent messages can contain date/time stamps. The message control system can also optionally act as a mini-server hosting one or more webpages which can be accessed by a remote browser instead of directly sending messages.

The present invention can also be used to monitor price changes on message boards such as LED message boards displaying prices of products like cigarettes. Here the entire content of messages between coming from the network to a message board can be reported back directly over the network.

In addition to monitoring or listening-in to communications between a sign controller and a price sign, the message control system can optionally perform diagnostics to check on the health of the sign controller, the sign or both. The results of these diagnostics can be stored in the message control system as a log and uploaded to a remote location from time to time.

### DESCRIPTION OF THE FIGURES

Attention is now directed to several drawings that illustrate features of the present invention:

FIG. 1 shows a prior art price sign system.

FIG. 2 shows monitoring prices changes on the system of FIG. 1 according to the present invention using an Active Messaging Control System (AMCS).

FIG. 3 shows an embodiment of the hardware of an AMCS.

FIG. 4 shows a routine that checks if a price change has been properly received and acknowledged by a price sign.

Several drawings and illustrations have been presented to aid in understanding the present invention. The scope of the present invention is not limited to what is shown in the figures.

### DESCRIPTION OF THE PREFERRED EMBODIMENT

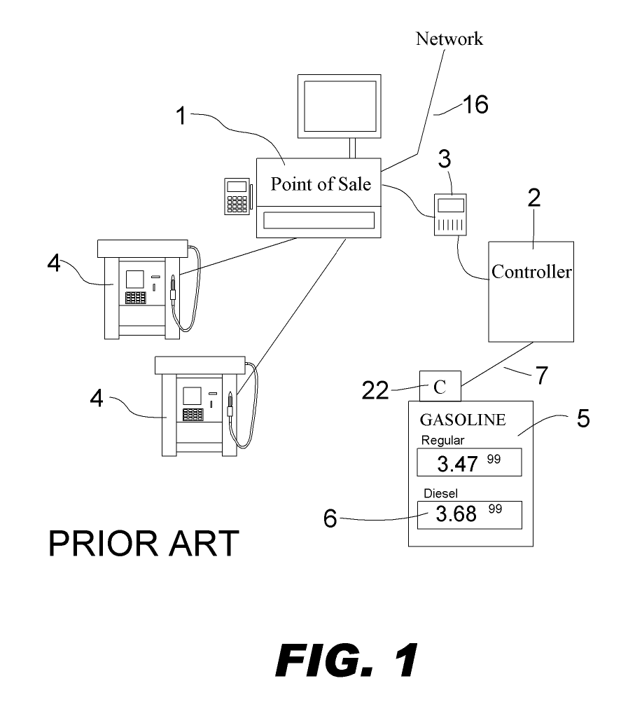

The present invention relates to a system and method for real-time price change monitoring of price signs. FIG. 1 shows a prior art system that might be found at a retail outlet like a gasoline station. A point of sale terminal 1 is connected through an interface 3 to a controller 2. This controller is usually located in the retailer's back office or elsewhere under control of the retailer. The-controller 2 is the device that sends the pricing to a sign controller 22 that is usually installed inside an electronic price sign 5. The sign controller 22 changes the price displayed on the sign. The point of sale system is also connected to a group of fuel pumps 4. The price sign 5 displays prices 6 of various fuels using LEDs or other display devices, and is supplied with a communication link 7 between the sign and the controller 2. This link 7 may be wired using a physical level wire technique such as RS-485, RS-232 known in the art, or any other method, or it may communicate wirelessly using any one of several wireless techniques known in the art. The point of sale system may also be coupled 16 to a network such as the Internet. A price change command can arrive over the network to the point of sale, or it may be originated locally. If it originates locally, it can be manually entered into the point of sale terminal 1. With some current systems, this is sufficient to cause the price sign 5 to change. With other systems, the retailer must enter the price change to the sign manually through the interface 3 of the controller or otherwise. The problem with these prior art systems is that the originator of the price change has no way of being sure that the sign and has changed correctly or whether they agree with each other. Also, there is no way to know whether the system is generally healthy.

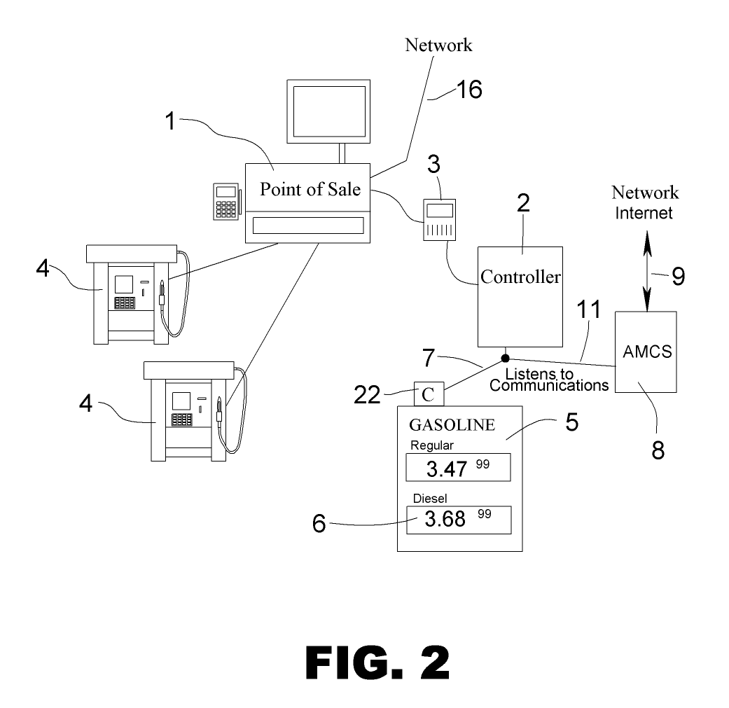

FIG. 2 shows a modification to current systems according to the present invention. An Active Messaging Control System (AMCS) 8 has been added, which reports directly through the Internet 9 on the network. This can be a small unit that is typically connected to the Internet or other network with an Ethernet connection to a network access point. It can thus act as either a network client or even as a mini-server originating messages or supplying webpages. The AMCS 8 can be specifically programmed to originate email messages to a set of predetermined parties, or to download files to one or more FTP or other sites. As stated, in a mini-server capacity it can optionally display its own secure webpages. The AMCS 8 can be totally updated over the network including email recipient lists, FTP site lists and software/firmware revisions. In a mini-server capacity, it can be updated as a website both in terms of webpages and links.

The AMCS 8 supplies a hardware interface that allows it to both communicate 10 with a controller 2 and to listen-in 11 on price sign commands from the controller to one or more price signs 5.

Typically, the AMCS 8 can be connected to the controller 2 using a wired method such as RS-485. However, any connection method is within the scope of the present invention. If the price sign 5 is also connected to the controller 2 using RS-485 or the like, the two connections can run in parallel. If the price sign 5 is connected to the controller 2 wirelessly, there is usually a separate wireless card in the controller for this. In this case, the AMCS 8 can listen-in either wirelessly using its own radio receiver, or it can listen-in by wire at the controller 2. Usually, the AMCS 8 has its own housing that resides very near the controller, so wire connections to the controller 2 are the least complex and the cheapest method. Any method of locating the AMCS to the controller, including inside the controller cabinet, is within the scope of the present invention. In addition to monitoring price sign changes, the AMCS 8 can also optionally monitor price changes to pumps and similar devices.

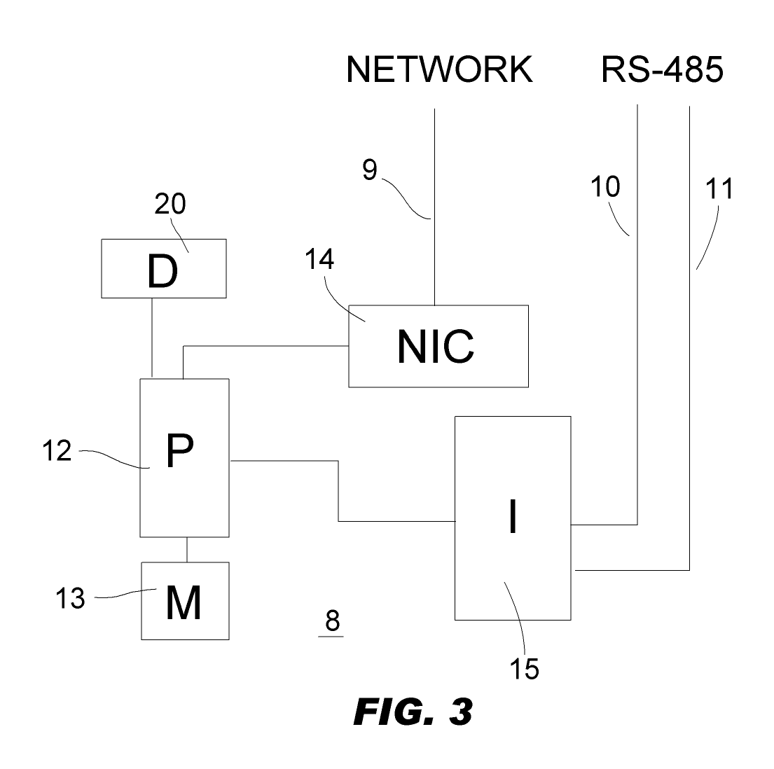

FIG. 3 shows a block diagram of a typically AMCS unit 8. A processor 12 communicates with a memory 13. The processor and memory may be separate units or may be in the same chip as with microcontrollers known in the art. The processor 12 can also communicate with an optional display 20, if present. A Network Interface Card (NIC) (or simply network interface) 14 connects 9 the processor 12 with a network such as the Internet usually by means of an Ethernet port known in the art. This allows the processor 12 to send email messages, files to FTP portals, and optionally return webpages. A controller interface 15 allows the AMCS 8 to both communicate 10 with a sign controller and to listen-in 11 to sign communications.

The memory 13 can store lists of email address, lists of FTP sites, along with login codes, and/or webpages. The memory 13 also stores an executable program that controls the process of listening-in to price sign communications. This program can be changed and/or updated through the network interface 14 from a remote location. Stored lists can likewise be updated. Typically, the executable program monitors the sign controller 2 through the controller interface 15 waiting for a price change command. When such a command is detected, the stored program can watch for an actual sign command to be sent from the controller 2 to the sign 5 with the new price, and it can optionally check status in the sign controller to make sure the new price has been properly recorded in the sign controller. While these are the typical ways the AMCS can check the price sign, any method of making sure the price sign is displaying the new price by listening-in is within the scope of the present invention.

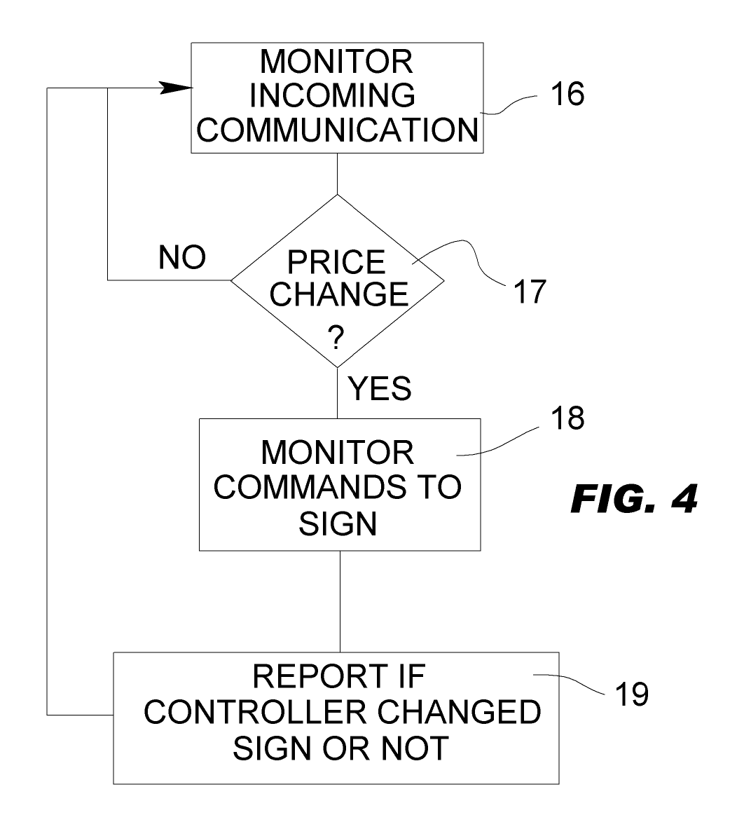

FIG. 4 shows a block diagram of a simple listening-in loop that might be executed by the processor 12 in the AMCS 8. Incoming communication to the sign controller 2 can be continuously monitored 16. Alternatively, price registers or other indicia of price in the sign controller 2 can be continuously monitored 16. When a price change is detected 17, control signaling to the sign can be listened to 18. If the correct price change signal is sent to the sign (with the correct new price), the program can either record this event, send messages by email or FTP 19, or take no action. If the sign did not change properly, error messages 19 can be sent the same way. All sent messages can contain a date/time stamp.

Some price signs 5 may send an electronic acknowledgement back to the sign controller 2 when a price change is made. The AMCS 8 can optionally monitor for such acknowledgements on systems where they are implemented.

When no changes are taking place, the AMCS 8 can run diagnostics on the sign system. Typically, this is done by ordering the sign controller 2 to run a particular check. It can also be done by reading status registers in the sign controller 2. The AMCS 8 can keep an internal log of such tests along with their results, or the test results can be communicated over the network to a remote location. Usually, a log will be communicated on a periodic basis through a process such as an FTP download. Diagnostics can also be optionally ordered from a remote location.

While particular embodiments of the present invention has described the AMCS 8 as being a separate unit from the controller 2 or the controller in the sign, this is not necessary. The AMCS 8 can optionally be an integral part of the controller 2 and supplied with it or a part of the sign controller in the sign.

As previously stated, there can be other types of displays such as LED message boards which may display the price of commodities such as cigarettes and other products or may display entirely different messages. In this case, the network communicates with a PC computer installed at the store level. The PC sends wired or wireless information to the LED message board. According to embodiments of the present invention, an AMCS listens to communication between the network and the message board, between the network and the PC, or between the PC and the message board. The AMCS can send the status of the message board directly on the network back to a control point or corporate headquarters as well as the content of messages. In addition, the AMCS can run diagnostics and check the health of the message board and it's associated system. In this embodiment of the present invention, the AMCS works similarly to the way previously described; however, it is not just monitoring and reporting prices, but also the content of messages to the message board.

Several descriptions and illustrations have been presented to aid in understanding the present invention. One with skill in the art will realize that numerous changes and variations may be made without departing from the spirit of the invention. Each of these changes and variations is within the scope of the present invention.

1. A method for verifying that a price sign has correctly changed a displayed price comprising:
providing a message control system adapted to monitor communications between a controller and a price sign;
based on said monitoring, causing said control system to send a message to a remote location when said displayed price did not change correctly upon command;
causing said message control system read at least one status register in said price sign and to keep an internal log of contents of said status register;
periodically transmitting said internal log to said remote location.

2. The method of claim 1 further comprising causing said message control system to send a message to a remote location whenever said price sign is commanded to change a displayed price.

3. The method of claim 1 wherein said message is an email message.

4. The method of claim 1 wherein said message is transmitted to an FTP portal.

5. The method of claim 1 wherein said message control system contains a list of message recipients.

6. The method of claim 5 wherein said list can be updated over a network from a remote location.

7. The method of claim 1 wherein said message control system contains a processor and an executable program, and wherein said executable program can be changed from a remote location.

8-9. (canceled)

10. The method of claim 1 wherein said message contains a date/time indication.

11. A method for verifying price sign changes at retail gasoline stations comprising:
supplying a message control system for use in a retail gasoline station, said message control system adapted to monitor messages between a controller and a price sign;
causing said message control system to send a message over a network to a remote location when said controller orders a price change on said price sign;
causing said message control system read at least one status register in said price sign and to keep an internal log of contents of said status register;
periodically transmitting said internal log to said remote location.

12. The method of claim 11 wherein said message is an email message.

13. The method of claim 11 wherein said message control system contains a processor with a memory and said memory contains message recipient lists and an executable program, and wherein said executable program or said recipient lists can be changed from a remote location.

14-15. (canceled)

16. The method of claim 11 wherein said message contains a date/time stamp.

17. A system for monitoring a price sign comprising:
a message monitoring interface coupled between a controller and a price sign, said message monitoring interface adapted to listen-in to signaling between said controller and said price sign;
wherein, said message monitoring interface includes a processor, a memory, a sign communications interface and a network access port, and wherein, said memory contains a list of message recipients;
and wherein said processor executes a stored program that causes said sign communication interface to monitor said signaling and to formulate and send over a network a message reporting content of said signaling including whether said sign correctly responded to a price change command;
and wherein said stored program is adapted to read at least one status register in said price sign, keep an internal log of contents of said status register and to periodically transmit said internal log to a remote location.

18. The system of claim 17 wherein said message is an email message.

19. The system of claim 17 wherein said message contains a date/time indication.

20. (canceled)
